(19) United States
(12) Patent Application Publication
(10) Pub. No.: US 2006/0129263 A1
(43) Pub. Date: Jun. 15, 2006

(54) Method and system for controlling tool process parameters

(75) Inventors: Shinn-Chih Wang, Citweng Township (TW); Shun-An Chen, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/010,760

(22) Filed: Dec. 13, 2004

(51) Int. Cl. G06F 19/00

(52) U.S. Cl. 700/108

(57) ABSTRACT

A system for controlling process parameters. The system contains first and second storage devices, and first and second processors. The first storage device stores first process parameters for the tools. The first processor retrieves the first process parameters from the first storage device and calculates a control limit for each of the tools accordingly. The second storage device stores the control limit information. The second processor receives second process parameters for the tool, retrieves corresponding control limit information from the second storage device, performs a statistical process control analysis accordingly, and generates an alarm signal for directing adjustment of the tool process parameters.

### BACKGROUND

The present invention relates to tool control and particularly to a control system for manipulating tool process parameters capable of controlling a tool without over-burdening a manufacturing execution system (MES) of a manufacturing system.

Manufacturing process control is conventionally accomplished by analyzing product parameters after a process run is finished. The product parameters are obtained through inspecting the product or work-in-process using various metrology tools, such as metrology tools for film thickness and critical dimension measurement. Tool process parameters are seldom taken into account in conventional process control methods and systems. According to the conventional process control, errors in the manufacturing process are corrected only after the mistake has been made, and the resulting yield loss has been incurred. As optical lithography pushes to smaller and smaller dimensions, patterned features smaller than the wavelength of light must be routinely manufactured. In such system, tiny deviations of tool process parameters make up an increasingly large share of manufacturing errors. The MES of the conventional system manipulates few, if any, tool process parameters. Additionally, MES is already burdened by control functions other than tool process parameter control. Therefore, in the conventional system very little capacity remains for controlling tool process parameters. In order to achieve real-time control of tools by means other than the conventional post-process correction, efficient control over tool process parameters is necessary.

FIG. 1 is a schematic view showing a conventional manufacturing system. A conventional manufacturing system 10 comprises a manufacturing execution system (MES) 11, a transaction process agent 13, tools 17a˜17n, and tool controllers 15a˜15n corresponding to each of the tools 17a˜17n. Using tool 17a as an example, tool 17a connects to tool controller 15a via a tool link 19a, wherein the tool controller 15a collects tool process parameters of tool 17a and saves them in a local buffer. The tool controller 15a transfers the tool process parameters of tool 17a to the transaction process agent 13 via a local network 18. The transaction process agent 13 receives the tool process parameters and relays them to MES 11. The MES 11 receives the tool process parameters and performs a statistical process control thereof for generating an operation command for the tool 17a accordingly. The operation command is sent to the tool controller 15a via the transaction process agent 13, thus the tool controller 15a controls the tool 17a accordingly. The MES 11, which directs all the operations in a fabrication facility, is the heart of a manufacturing system. As more and more functions are integrated into MES 11, little capacity is left for tool process parameters. Adding significant tool process parameters exceeds the processing capacity of MES 11, thus only a few tool process parameters can be taken into account by the MES 11. Accordingly, efficient and real-time control for tool process parameters cannot be achieved by the conventional system.

Hence, there is a need for a control system for tool process parameters that addresses the problems arising from the existing technology.

### SUMMARY

It is therefore an object of the invention to provide a tool control system and method capable of efficient, real-time control of tool process parameters.

Another object of the present invention is to provide a tool control system and method capable of controlling tool process parameters without burdening the MES in a manufacturing system.

To achieve the above objects, the present invention provides a system and method capable of analyzing tool process parameters off-line and adjusting tool process parameters in real-time to achieve efficient tool control. By manipulating the enormous number of tool process parameters offline outside the MES, the tool control system and method enhances product yield and relieves the MES of the heavy burden of manipulating tool process parameters.

According to the present invention, a system for controlling process parameters of a plurality of tools is provided. The system contains first and second storage devices, and first and second processors. The first storage device stores first process parameters for the tools. The first processor retrieves the first process parameters from the first storage device and calculates a control limit for each of the tools accordingly. The second storage device stores the control limit information. The second processor receives second process parameters for the tool, retrieves corresponding control limit information from the second storage device, performs a statistical process control analysis accordingly, and generates an alarm signal when direct adjustment of the tool process parameter is required.

The present invention also provides a method of controlling tool process parameters, which is implemented in the aforementioned system. First, process parameters for a plurality of tools are received. Second, a first database is established for storing the process data. Then the process parameters are analyzed to determine control information for each of the tools. A second database is established for storing the control information. Next, a statistical process control analysis is performed to analyze the process parameters according to the control information. Then, an alarm signal is issued according to the statistical process control analysis for directing adjustment of the tool process parameters.

The above-mentioned method may take the form of program code embodied in a tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional manufacturing system;

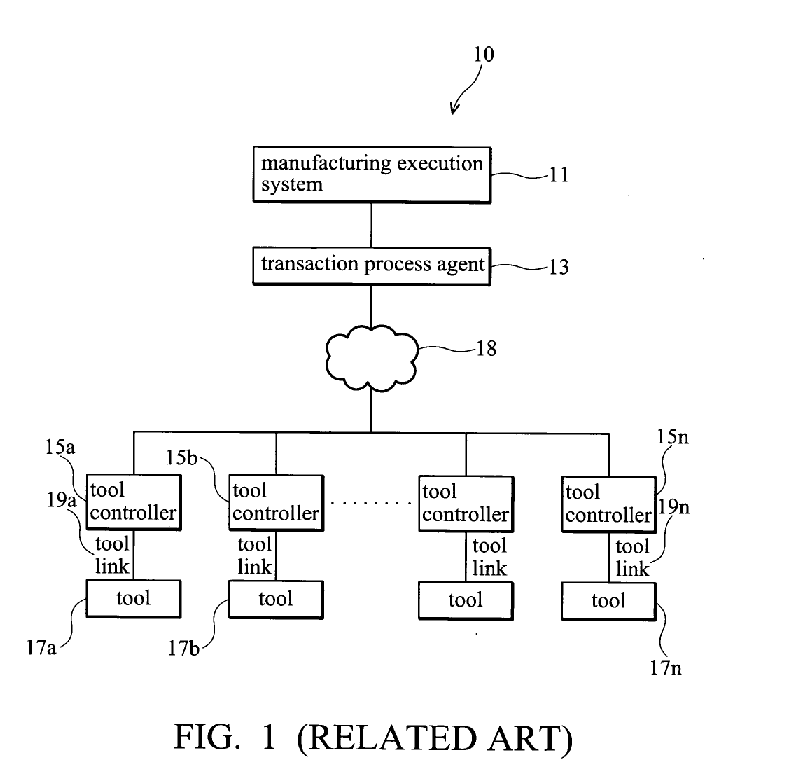

FIG. 2 is a schematic view showing a manufacturing system according to the present invention;

FIG. 3 is a schematic view showing the tool process parameter control system of FIG. 2;

FIG. 4 illustrates a flowchart of the tool control method of the tool process parameter control system in FIG. 2; and

FIG. 5 is a diagram of a storage medium for storing a computer program providing a method for tool control according to the present invention.

### DETAILED DESCRIPTION

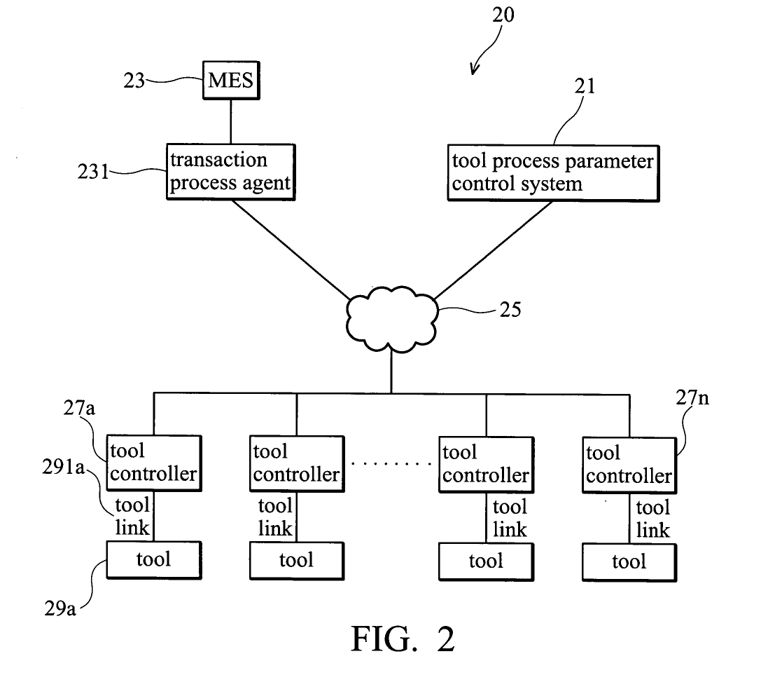

The present invention will now be described with reference to FIGS. 2 to 5, which in general relate to a tool control system.

FIG. 2 is a schematic view showing a manufacturing system according to the present invention. A manufacturing system 20 contains a MES 23, a transaction process agent 231, a tool process parameter control system 21, tools 29a˜29n, and tool controller 27a˜27n. Tool 29a connects to tool controller 27a via a tool link 291a, wherein the tool controller 27a collects tool process parameters for tool 29a and saves them in a local buffer. The tool controller 27a transfers the tool process parameters for tool 29a to tool process parameter control system 21 via a network 25. Tool process parameter control system 21 receives the tool process parameters, stores them, manipulates them to determine a control limit for each of the tools accordingly, and determines whether to issue an alarm signal to the MES 23 for directing an adjustment of the tool process parameters. The MES 21 receives the alarm signal via the transaction process agent 231 and the network 25, and issues a control command to the tool controller 27a for directing the tool 29a.

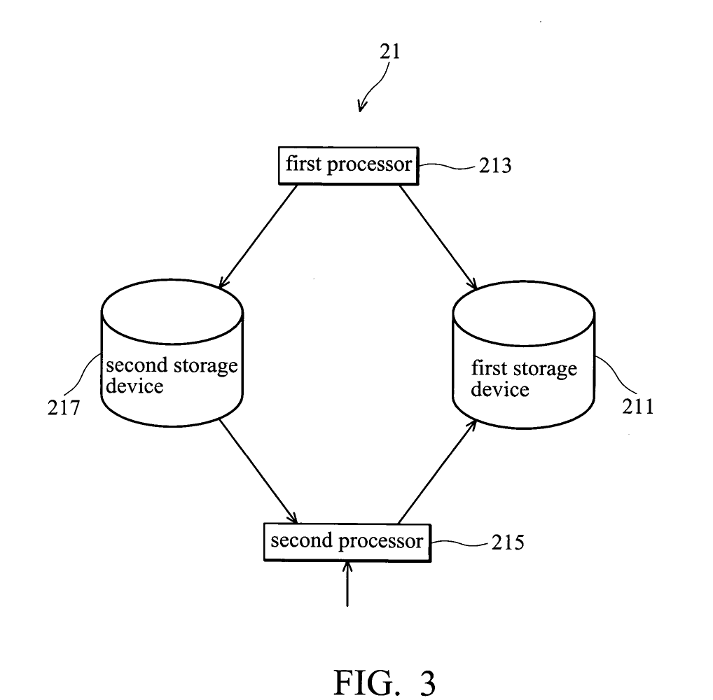

FIG. 3 is a schematic view showing the tool process parameter control system of FIG. 2. The tool process parameter control system 21 comprises first and second storage devices 211 and 217, and first and second processors 213 and 215. The first storage device 211 stores first process parameter of the tools, wherein the first process parameter comprises historical tool process parameters collected from the tool controllers 27a˜27n. The first processor 213 retrieves the first process parameter from the first storage device 211 and calculates a control limit for each of the tools 29a˜29n according to the first process data, respectively. The first processor 213 operates offline. Therefore, the enormous number of tool process parameters involved in the control limit calculation will not impact the efficiency of the tool process parameter control system 20. The second storage device 215 stores the control limit information. The second processor 215 receives second process parameters from the tool controllers 27a˜27n, wherein the second process parameters comprise current tool process parameters for the tools 29a˜29n. The second processor 215 retrieves corresponding control limit information from the second storage device 217 and performs a statistical process control analysis for the second process parameter accordingly. Then the second processor 215 generates an alarm signal according to the statistical process control analysis for directing adjustment of the tools 29a˜29n. The second processor 215 operates online to perform real-time tool control.

The second processor 213 further comprises buffer cache 2135 storing recently used control information. The buffer cache is refreshed according to a least recently used (LRU) mechanism.

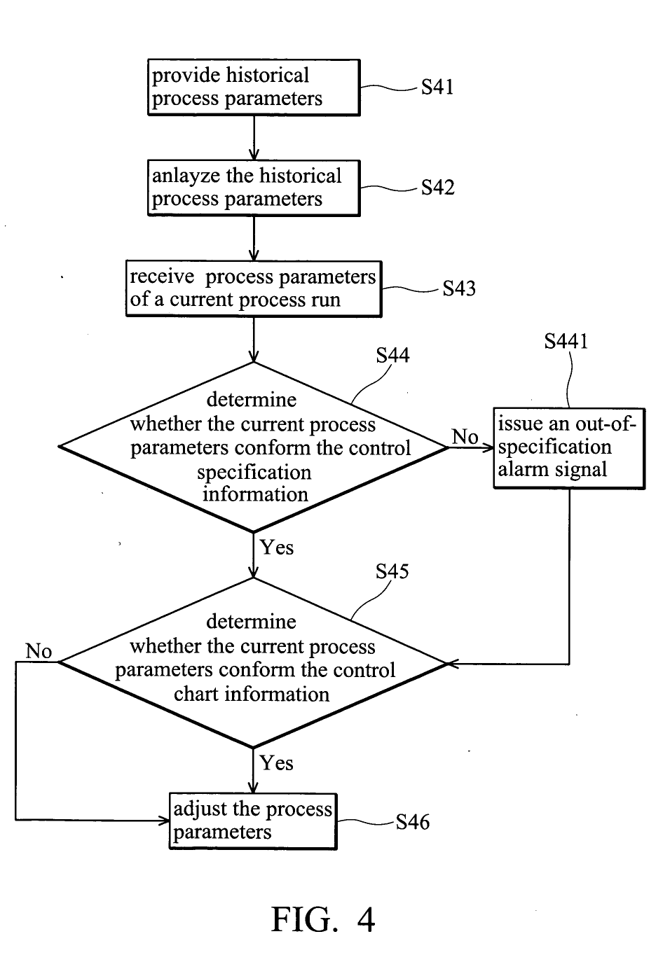

FIG. 4 illustrates a flowchart of the tool control method of the tool process parameter control system in FIG. 2.

First, historical process parameters of a plurality of tools are provided (step S41). The historical process parameter mainly comprises information regarding tool process parameters, such as temperature and pressure, collected during a plurality of preceding process runs. The historical process parameter is collected by corresponding tool controller 27 and relayed to the second processor 215. The second processor 215 then stores the historical process parameter in the first storage device 211, which is connected directly to the first and second processors 213 and 215.

Second, the historical process parameters are analyzed to determine control information for each of the tools (step S42). The control information comprises information regarding control specifications, control charts, and control rules for process parameters of each tool. The control information determination is performed offline outside the MES, thus the capacity of the MES can be preserved for overall tool control operations. According to this embodiment, the control information is stored in the second storage device 217.

Next, process parameters for a current process run of a tool are received (step S43). The current process parameters comprise information regarding tool process parameters, such as temperature and pressure, collected during a current process run. The current process parameters are collected by corresponding tool controller 27 and relayed to the second processor 215.

After the current process parameter is received, a statistical process control analysis is performed. The statistical process control analysis is performed by the second processor 215, analyzing the current process parameter according to the control information. After being analyzed, the current process parameters are stored in the first storage device 211 and assessed as historical process data. In step S44, it is determined whether the current process parameters conform to the control specification information, and if not, an out-of-specification alarm signal is issued (step S441). In step S45, it is determined whether the current process parameters conform to the control chart information, and if not, an out-of-control alarm signal is issued (step S451). The out-of-specification and out-of-control alarm signals are sent to a corresponding tool controller and direct the adjustment of process parameters for the corresponding tools (step S46). The threshold for determining the conformation between the current process parameters and the control specification and control chart information is specified in the control rule information. The control rule information comprises a percentage setting rule and wafer-to-wafer and lot-to-lot gating rules. In order to facilitate the calculation, buffer cache 2135 stores recently used control information. The buffer cache is refreshed according to a least recently used (LRU) mechanism.

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

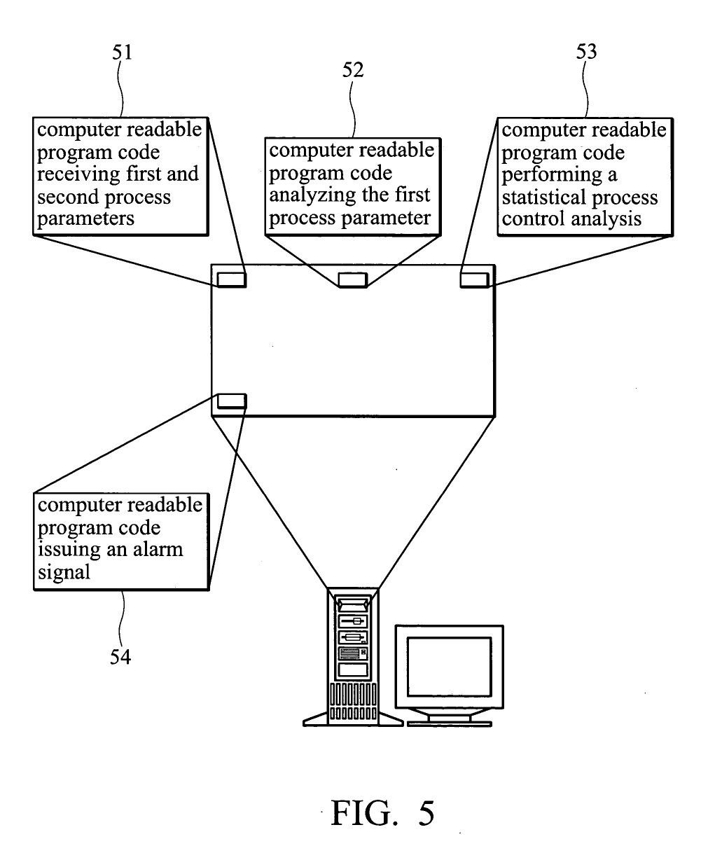

FIG. 5 is a diagram of a storage medium for storing a computer program providing the method of controlling tool process parameters of the present invention. The computer program product comprises a computer usable storage medium having computer readable program code embodied in the medium, the computer readable program code comprising computer readable program code 51 receiving first and second process parameters for a plurality of tools, computer readable program code 52 analyzing the first process parameter to determine control information for each of the tools, computer readable program code 53 performing a statistical process control analysis analyzing the second process parameters according to the control information, and computer readable program code 54 issuing an alarm signal according to the statistical process control analysis for directing adjustment of the tools.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for controlling tool process parameters, comprising:
providing first process parameters for a plurality of tools;
analyzing the first process parameters to determine control information for each of the tools, wherein the control information is calculate using an offline mechanism;
receiving second process parameters from tool controllers for the tools;
performing a statistical process control analysis analyzing the second process parameters according to the control information; and
issuing an alarm signal according to the statistical process control analysis for directing adjustment of the tools.

2. The method of claim 1, wherein the control information comprises control specification information for the second process parameters.

3. The method of claim 2, wherein the statistical process control analysis determines whether the second process parameter conforms to the control specification information, and if not, an out-of-specification alarm signal is issued.

4. The method of claim 1, wherein the control information further comprises control chart information for the second process parameters.

5. The method of claim 4, wherein the statistical process control analysis determines whether the second process parameter conforms to the control chart information, and if not, an out-of-control alarm signal is issued.

6. (canceled)

7. The method of claim 1, further providing control rule information for specifying conditions for alarm signal generation.

8. The method of claim 7, wherein the control rule information comprises a percentage setting rule and wafer-to-wafer and lot-to-lot gating rules.

9. The method of claim 1, further providing a buffer cache storing recently used control information.

10. The method of claim 9, further refreshing the buffer cache using a least-recently-used mechanism.

11. A system for controlling process parameters for a plurality of tools, comprising:
a first storage device storing first process parameters for the tools;
a first processor retrieving the first process parameters from the first storage device and determining control information for each of the tools accordingly, wherein the first processor operates offline;
a second storage device storing the control information; and
a second processor receiving second process parameters from tool controllers for the tools, retrieving corresponding control information from the second storage device, performing a statistical process control analysis accordingly, and generating an alarm signal for directing adjustment of the tools.

12. The system of claim 11, wherein the control information comprises control specification information for tool process parameters.

13. The system of claim 12, wherein the second processor further determines whether the second process parameters conform to the control specification information, and if not, an out-of-specification alarm signal is issued.

14. The system of claim 11, wherein the control information further comprises control chart information for tool process parameters.

15. The system of claim 14, wherein the second processor further determines whether the process parameters conform to the control chart information, and if not, an out-of-control alarm signal is issued.

16. (canceled)

17. The system of claim 11, wherein the first storage device further stores control rule information for specifying conditions for alarm signal generation.

18. The system of claim 17, wherein the control rule information comprises a percentage setting rule and wafer-to-wafer and lot-to-lot gating rules.

19. The system of claim 17, further comprising a buffer cache storing recently used control information.

20. The system of claim 19, wherein the second processor further refreshes the buffer cache according to a least-recently-used mechanism.

21. A computer readable storage medium for storing a computer program providing a method for controlling tool process parameters, the method comprising:
receiving first process parameters for a plurality of tools;
analyzing the first process parameters to determine control information for each of the tools, wherein the control information is calculated offline;
receiving second process parameters for the tools;
performing a statistical process control analysis analyzing the second process parameter according to the control information; and
issuing an alarm signal according to the statistical process control analysis for directing adjustment of the tools.

22. The storage medium of claim 21, wherein the control information comprises control specification information for tool process parameters.

23. The storage medium of claim 22, wherein the statistical process control analysis determines whether the second process parameters conform to the control specification information, and if not, an out-of-specification alarm signal is issued.

24. The storage medium of claim 21, wherein the control information further comprises control chart information for tool process parameters.

25. The storage medium of claim 24, wherein the statistical process control analysis determines whether the process parameters conform to the control chart information, and if not an out-of-control alarm signal is issued.

26. (canceled)

27. The storage medium of claim 21, wherein the method further provides control rule information for specifying conditions for alarm signal generation.

28. The storage medium of claim 21, wherein the control rule information comprises a percentage setting rule and wafer-to-wafer and lot-to-lot gating rules.

29. The storage medium of claim 21, wherein the method further refreshes a buffer cache storing recently used control information using a least-recently-used mechanism.
